(19) United States
(12) Patent Application Publication
(10) Pub. No.: US 2006/0235191 A1
(43) Pub. Date: Oct. 19, 2006

(54) Method for producing polyamides

(75) Inventors: Jürgen Deininger, Oftersheim (DE); Jürgen Demeter, Ludwigshafen (DE); Gad Kory, Gaiberg (DE); Oliver Sötje, Mannheim (DE); Helmut Winterling, Ludwigshafen (DE); Peter Zehner, Ludwigshafen (DE); Michael Heeger, Ludwigshafen (DE); Martin Gann, Freinsheim (DE); Axel Polt, Ludwigshafen (AT); Ulrich Treuling, Bensheim (DE); Werner Weinle, Bad Friedrichshall (DE)

Correspondence Address: CONNOLLY BOVE LODGE & HUTZ LLP, SUITE 800, 1990 M STREET NW, WASHINGTON, DC, 20036-3425, US

(73) Assignee: BASF Aktiengesellschaft, Ludwigshafen (DE)

(21) Appl. No.: 10/550,491

(22) PCT Filed: Mar. 19, 2004
(86) PCT No.: PCT/EP04/02875

§ 371 Date: Sep. 26, 2005

(30) Foreign Application Priority Data
Mar. 26, 2003 (DE) 103 13 681.9

(51) Int. Cl. C08G 69/08

(52) U.S. Cl. 528/310

(57) ABSTRACT

Polyamides, oligomers thereof or mixtures thereof, if required with further reaction products, are prepared by reacting aminonitriles or dinitriles and diamines or a mixture containing aminonitrile, dinitrile and diamine, and, if required, further polyamide-forming monomers and/oligomers with water in a reactor (1) having a vertically oriented longitudinal axis, by a process in which, in the reactor (1), the reaction product is removed from the bottom and ammonia formed and any further low molecular weight compounds formed and water are taken off via the top (2), wherein the reactor (1)
has at least two chambers (4) arranged one on top of the other in the longitudinal direction,
the chambers (4) being separated from one another by liquid-tight trays (5),
each chamber (4) being connected by a liquid overflow (6) to the chamber (4) directly underneath and a liquid product stream being taken off by the liquid overflow (6) of the lowermost chamber (4),
the gas space (7) above the liquid level in each chamber (4) being connected to the chamber (4) arranged directly above in each case by one or more conduit pipes (8) which in each case opens or open into a gas distributor (9) having orifices (11) for gas exit below the liquid level,
and comprising in each case at least one baffle plate (12) which is arranged vertically around each gas distributor (9) and whose upper end terminates below the liquid level and whose lower end terminates above the liquid-tight tray (5) of the chamber (4) and which separates each chamber (4) into one or more gassed (13) and into one or more ungassed (14) spaces.

The present invention relates to a process for the preparation of polyamides, oligomers thereof or mixtures thereof, if required with further reaction products, by reaction of aminonitriles or of dinitriles and diamines or of a mixture containing aminonitrile, dinitrile and diamine and, if required, further polyamide-forming monomers and/or oligomers with water.

Processes for the preparation of polyamides, oligomers thereof or mixtures thereof, if required with further reaction products, by reaction of aminonitriles or of dinitriles and diamines or of a mixture containing aminonitrile, dinitrile and diamine and, if required, further polyamide-forming monomers and/or oligomers with water, in particular continuous processes of this type, are known.

Thus, WO 99/43732 describes the procedure for such processes, in particular continuous ones, in a reactive distillation apparatus, heat being introduced into the lower part of the reactive distillation apparatus. The reaction products are removed from the bottom of the reactive distillation apparatus, and ammonia formed in the reaction, any further low molecular weight compounds formed and water are removed via the top. Tray columns, bubble columns and dividing wall columns are mentioned as possible reactive distillation columns.

U.S. Pat. No. 6,201,096 describes the procedure for such processes, in particular continuous ones, in a reactive distillation apparatus, steam being introduced in the lower part of the reactive distillation apparatus. The high molecular weight compounds obtained as product are removed from the bottom of the reactive distillation apparatus. Tray columns, such as those having perforated trays, are mentioned as possible reactive distillation columns. According to U.S. Pat. No. 6,437,089, a mixture of 6-aminocapronitrile and caprolactam can be used as starting monomer in the process described in U.S. Pat. No. 6,201,096.

In order to ensure a uniform temperature, according to U.S. Pat. No. 6,201,096 and U.S. Pat. No. 6,437,089 all or most of the trays of the column should be equipped with aids for independent regulation of the temperature of the trays, for example with heating elements.

According to WO 99/43732, phase mixing is limited owing to the small liquid holdups on the trays in said processes. In order to improve the phase mixing, the liquid holdup on the trays could be increased. However, this leads to a higher pressure drop on the gas side above the trays. This results in a greater temperature spread over the trays and consequently very different reaction rates. This can lead to decompositions of the product in the lower part of the reactor, while the reaction ceases in the upper part of the reactor owing to excessively low temperature.

Moreover, it is the object of said processes to effect a separation of the mixture of water and ammonia and of polymeric products by rectification into top and bottom product. This requires a temperature gradient over the height of the apparatus in order to achieve the desired separation effect.

Thus, according to WO 00/24808, in the upper part of the described multistage reactor, the temperature and moreover the water content should be established in such a way that on the one hand sufficient hydrolysis is ensured but on the other hand escape of low molecular weight reaction products in gaseous form is avoided.

The polymerization in said multistage reactor thus has the disadvantage that the low temperatures required for limiting the escape of low molecular weight organic compounds in gaseous form in the upper part of the apparatus does not permit optimum hydrolysis of the nitrile groups and amido groups in an appropriate residence time. In the lower part of the multistage reactor, such low water content is present at high temperatures that the viscosity of the product melt is increased so that high flow losses result on the gas side and additionally external energy in the form of stirring energy has to be supplied in order to ensure sufficient mixing. Furthermore, the product is damaged at high temperatures.

What is desirable in these processes is to achieve a more uniform temperature profile over the longitudinal axis of the reactor and to improve the mixing of the reaction components, which lead to a reduction in the average reaction time and thus enable the process for the preparation of polyamides to be carried out in a technically simple and economical manner with avoidance of said disadvantages.

Accordingly, we have found a process for the preparation of polyamides, oligomers thereof or mixtures thereof, if required with further reaction products, by reaction with aminonitriles or dinitriles and diamines or a mixture containing aminonitrile, dinitrile and diamine, and, if required, further polyamide-forming monomers and/or oligomers with water in a reactor (1) having a vertically oriented longitudinal axis, in which, in the reactor (1), the reaction product is discharged from the bottom and ammonia formed and any further low molecular weight compounds formed and water are taken off via the top, wherein the reactor (1)
has at least two chambers (4) arranged one on top of the other in the longitudinal direction,
the chambers (4) being separated from one another by liquid-tight trays (5),
each chamber (4) being connected by a liquid overflow (6) to the chamber (4) directly underneath and a liquid product stream being taken off by the liquid overflow (6) of the lowermost chamber (4),
the gas space (7) above the liquid level in each chamber (4) being connected to the chamber (4) arranged directly above in each case by one or more conduit pipes (8) which in each case opens or open into a gas distributor (9) having orifices (11) for gas exit below the liquid level,
and comprising in each case at least one baffle plate (12) which is arranged vertically around each gas distributor (9) and whose upper end terminates below the liquid level and whose lower end terminates above the liquid-tight tray (5) of the chamber (4) and which separates each chamber (4) into one or more gassed (13) and into one or more ungassed (14) spaces.

The process can preferably be carried out continuously.

The process can advantageously be carried out adiabatically via reactor (1), preferably via the chambers (4), in particular via the chambers (4) with the exception of the lowermost chamber (4).

Reactor (1) is an apparatus which ensures excellent phase mixing in multiphase reactions and a virtually constant composition of the reaction mixture in each case over the total volume in each chamber, i.e. both over the cross section thereof and in particular over the liquid height, without moving apparatus parts, by air-lift circulation of the liquid, with simultaneous simple separation between liquid and gaseous phase after the reaction is complete. By means of the gas exit from the gas distributor into the liquid space between gas distributor and the baffle plate or baffle plates arranged vertically around the gas distributor, the hydrostatic pressure in this liquid space is reduced compared with the ungassed liquid space, resulting in a pressure gradient which is converted into kinematic energy. This pressure gradient puts the air-lift circulation into operation in the form of a flow which is directed upward in the gassed space, i.e. in the space between the gas distributor and the baffle plate or baffle plates arranged around the gas distributor, is deflected by the baffle plate or baffle plates in the region above the uppermost end of the baffle plate or baffle plates and below the liquid level, flows from top to bottom through the ungassed liquid space outside the baffle plate or baffle plates and is deflected again above the liquid-tight tray of the chamber and below the lowermost end of the baffle plate or baffle plates into a flow directed from bottom to top, with the result that the loop movement is closed.

The reactor is an apparatus comprising a vertically oriented longitudinal axis, i.e. an upright apparatus with feed of one or more liquid, liquid/solid, gaseous/liquid or gaseous/liquid/solid starting material streams in its upper region and a gaseous stream—starting material and/or inert gas—in its lower region, i.e. with countercurrent feed of the liquid, liquid/solid or gaseous stream.

Furthermore, one or more liquid, liquid/solid, gaseous/liquid or gaseous/liquid/solid streams—starting material, intermediate, product or inert gas or mixtures of a plurality or of all such substances—can be fed into the middle or lower region of reactor (1). Compounds which have no nitrile groups, preferably diamines, are advantageous for such a feed into the middle or lower region of reactor (1), in particular in the preparation of polyamides from dinitriles and diamines or from a mixture containing aminonitrile, dinitrile and diamine.

The reactor (1) comprises a plurality of chambers preferably arranged one above the other.

The number of chambers may advantageously be not more than 200, preferably not more than 50, in particular not more than 10.

The number of chambers may advantageously be at least 2, in particular at least 3.

The geometry of the reactor is frequently cylindrical, but other geometries are also possible.

The chambers are separated from one another by liquid-tight trays, each chamber being connected by one liquid overflow each to the chamber located directly underneath. The liquid overflow may be, for example, in the form of a pipe or of a shaft and it may be arranged both inside and outside the reactor. In particular, the liquid overflows of two successive chambers may be arranged in each case on opposite sides of the reactor. A liquid product stream is taken off from the lowermost chamber via the liquid overflow thereof. The lowermost chamber of the reactor (1), i.e. the bottom region, can be divided into at least two chambers. These at least two chambers can be arranged side by side or one on top of the other or one on top of the other and side by side.

In a preferred embodiment, a part or the product stream removed from the bottom region of the reactor (1) can be fed in liquid form to a heat exchanger, some or all of the water contained in the product stream can be converted into the gaseous state with the aid of this heat exchanger and the mixture leaving the heat exchanger can be fed to the reactor (1). Polyamides, oligomers or mixtures thereof obtained according to the process can preferably be removed from reactor (1) as product in liquid form, in particular in the bottom region.

In another preferred embodiment, a part or the totality of the product stream removed from the bottom region of the reactor (1) can be fed in liquid form to a heat exchanger, some or all of the water contained in the product stream can be converted into the gaseous state with the aid of this heat exchanger, the gaseous water can be fed to the reactor (1) and the liquid product leaving the heat exchanger can be obtained as desired product.

In a further preferred embodiment, product in liquid form can be fed from at least one of the chambers present in the bottom region of the reactor (1) to a heat exchanger, some or all of the water contained in the product stream can be converted into the gaseous state with the aid of this heat exchanger and the mixture leaving the heat exchariger can be fed to the reactor (1). Polyamides, oligomers or mixtures thereof obtained according to the process can preferably be removed from the reactor (1) as product in liquid form, in particular in the bottom region.

In a further preferred embodiment, product in liquid form can be fed from at least one of the chambers present in the bottom region of the reactor (1) to a heat exchanger, some or all of the water contained in the product stream can be converted into the gaseous state with the aid of this heat exchanger, the gaseous water can be fed to the reactor (1) and the liquid product leaving the heat exchanger can be obtained as desired product.

The heat exchanger used in these preferred embodiments may be present in the reactor (1) or outside the reactor (1) or partly inside and partly outside the reactor (1). Furthermore, the heat exchanger may comprise an apparatus or a plurality of separate apparatuses.

The gas space above the liquid level in each chamber is connected to the chamber arranged in each case immediately above by one or more conduit pipes which in each case opens or open into a gas distributor having orifices for gas exit below the liquid level. There are in principle no restrictions with regard to the number and arrangement of the conduit pipes: it is just as possible to provide a single central conduit pipe or a plurality of conduit pipes distributed over the reactor cross section. Instead of a single gas distributor per chamber, it is also possible to provide a plurality of separate gas distributors, each having a gas feed via one or more conduit pipes. A gaseous stream is passed into the gas distributor of the penultimate chamber of the reactor via one or more conduit pipes from outside the reactor and/or from the bottom region.

It is therefore just as possible to provide a single gas distributor, with gas feed via one or more conduit pipes, and a plurality of gas distributors not connected to one another and each having a gas feed via one or more conduit pipes.

There are no fundamental restrictions with regard to the gas distributors which can be used here; what is important is that the gas distributor enables the gas fed to it via the conduit pipe or pipes to emerge from the gas space of the chamber located directly underneath, below the liquid level of the chamber in which the gas distributor is arranged. The gas exit should preferably take place as uniformly as possible. In principle, a commercial gassing means can be used as a gas distributor, for example gas distributors in the form of pipes which are equipped with outlet orifices for the gas and can be arranged, for example, horizontally, i.e. in a plane parallel to the liquid-tight tray of the chamber. It is also possible to provide annular gas distributors. The orifices for the gas exit must, however, always be present below the liquid level in the chamber, preferably at a distance from the liquid level of at least 10%, preferably at least 30%, particularly preferably at least 50%, of the total liquid height in the chamber. It has been found that a particularly advantageous depth of immersion of the orifices for the gas exit below the liquid level in the chamber is at least 50 mm.

In a preferred embodiment, the gas distributor or distributors is or are siphon-like, in the form of a hood which is closed at the top and has orifices for gas exit in the lower part thereof.

Apart from the passages for the conduit pipe or pipes for the gas feed and the gas exit orifices in its lower part, the hood can be completely closed.

However, it is also possible for the hood to be formed in such a way that it is open in its lower part.

The upper closed end of the hood can terminate below the liquid level but it may also extend beyond the liquid level, into the gas space.

The hood of the siphon-like gas distributor can in principle have any geometrical shape; it is possible, for example, for it to comprise a plurality of parts which are connected to one another and are arranged in cross section preferably crosswise and/or parallel or concentrically or radially.

With regard to number, cross section and distance from the liquid level in the chamber, the orifices for gas exit are preferably formed in such a way that the pressure drop of the gaseous stream in the gas distributor is from 0.1 to 50 mbar.

The orifices for the gas distributor are preferably arranged at the same height relative to one another.

They can in principle have any geometrical shape and may be, for example, circular, triangular or slot-like.

The central line of the orifices is preferably a distance of from about 1 to 15 cm from the lower end of the hood. Alternatively, it is also possible, instead of orifices, to form the lower end of the hood with a serrated edge. In a further alternative, it is possible to form the lower end of the hood in the form of a ring distributor.

The arrangement of the orifices at different heights relative to one another may be advantageous for operation with two or more load ranges.

The height of the orifices for gas exit is chosen according to requirements as a function of the specific reaction to be carried out in the reactor in such a way that, on the one hand, sufficient mass transfer area is offered for the specific gas/liquid or gas/liquid/solid reaction and, on the other hand, sufficient drive is provided for the air-lift circulation of the liquid.

At least one vertical baffle plate whose upper end terminates below the liquid level in the chamber and is a distance away from the tray of the chamber and which separates each chamber into one or more gassed and one or more ungassed spaces is arranged around each gas distributor in the novel reactor.

In a preferred embodiment, the baffle plate may be in the form of a cylindrical inserted pipe. For example, the form of a simple flat metal sheet is however also possible.

The at least one baffle plate is a distance away from the liquid level and from the tray of the chamber, preferably such that substantially no throttling of the liquid flow by the baffle plate occurs. The distances of the baffle plate or of the baffle plates from the liquid surface and also from the tray of the chamber should therefore preferably be established in that the flow rate of the liquid on deflection by the baffle plate is changed only slightly, if at all.

There are in principle no restrictions with regard to the total height of the baffle plate. This may be appropriately dimensioned in particular with function of the desired residence time per chamber, simultaneously ensuring sufficient mixing.

In a preferred embodiment, a solid catalyst may be introduced into one or more, preferably into all, chambers of the reactor, in particular as a solid bed or in the form of catalyst-coated stacked packings, for example monoliths.

More preferably, an ion exchange resin can be introduced into one or more, preferably into all, chambers.

The reactor therefore has the advantage that, for gas/liquid or gas/liquid/solid reactions, it ensures very good phase mixing and hence a high conversion and, after mixing and reaction are complete, substantial separation of gaseous and liquid phase. Since all that is required for driving the air-lift circulation is that the gas exit from the gas distributor takes place below the liquid level in the chamber, it being possible for the distance from the gas exit to the liquid level to be varied in principle in very wide limits, the novel reactor provides an apparatus in which liquid residence time and gas pressure drop are substantially decoupled.

The reactor is explained in more detail with reference to figures:

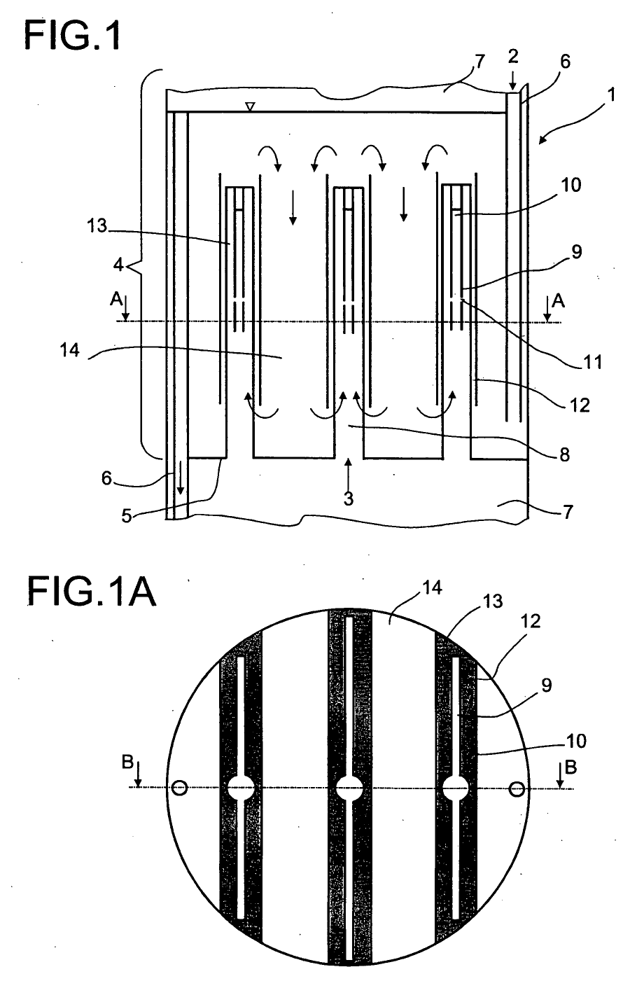

FIG. 1 shows a longitudinal section through a first embodiment of a chamber (4) of a reactor (1), with cross section in FIG. 1a, and

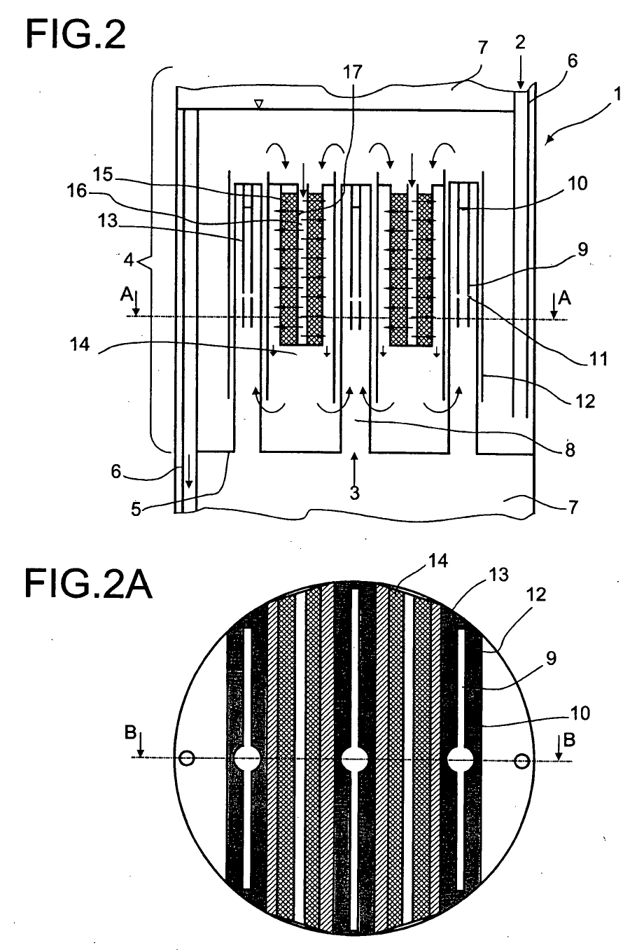

FIG. 2 shows a longitudinal section through a chamber (4) of a second embodiment of a reactor (1), with cross section in FIG. 2a, and

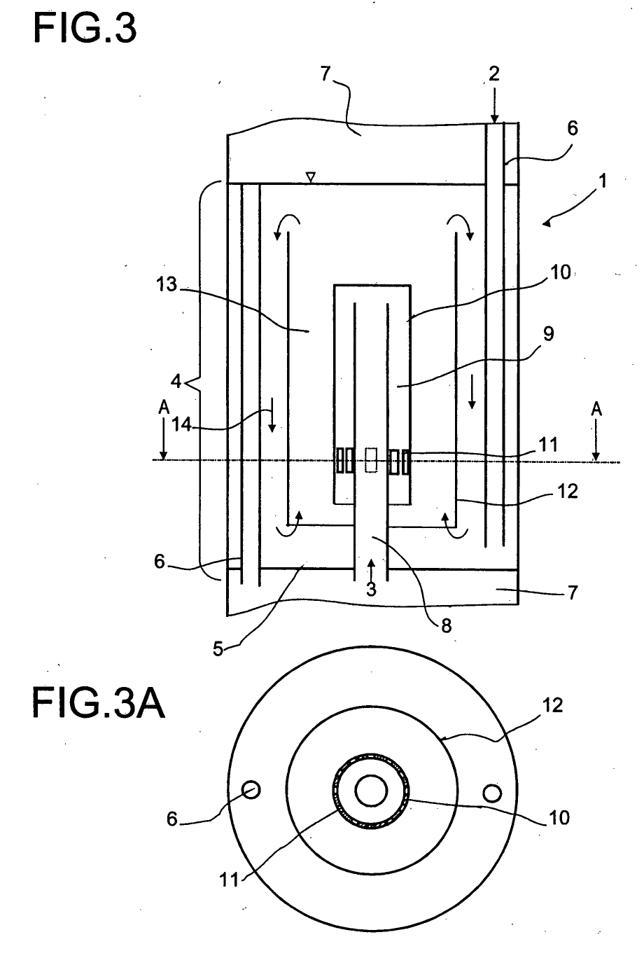

FIG. 3 shows a longitudinal section through a chamber (4) of a third embodiment of a reactor (1), with cross section in FIG. 3a.

FIG. 1 shows, by way of example, one of a plurality of chambers 4 of a reactor 1 which are arranged one on top of the other in the longitudinal direction, comprising feed 2 of a liquid or gas/solid starting material stream in the upper region and a gaseous stream 3 in the lower region of the reactor 1, comprising in each case one tray 5 per chamber 4, liquid overflows 6 which are shown by way of example internally in the reactor 1, comprising in each case a gas space 7 above the liquid level in each chamber 4, which space is connected by way of example by a conduit pipe 8 to the chamber 4 located above in each case and opens into a siphon-like gas distributor 9 in the form of a hood 10 closed at the top and having orifices 11 for gas exit in the lower part thereof. Arranged around the siphon-like gas distributor 9 are baffle. plates 12 which in each case are a distance away from the liquid level and from the tray of the chamber 4 and which separate the chamber 4 into a plurality of gassed spaces 13 and a plurality of ungassed spaces 14.

In the cross sectional diagram in FIG. 1a, the shape of the hood 10 of the gas distributor 9 is illustrated, in the present case, by way of example, in the form of parts arranged parallel.

In the longitudinal section of a further exemplary embodiment in FIG. 2, identical reference numerals denote features identical to those in FIG. 1.

The catalyst 15 introduced is additionally indicated in the region of the ungassed space 14.

In the cross sectional diagram in FIG. 2a, the shape of the hood 10 of the gas distributor 9 is illustrated in the present case, by way of example, in the form of parts arranged parallel.

In the longitudinal section of a further exemplary embodiment in FIG. 3, identical reference numerals denote features identical to those in FIG. 1.

The cross sectional diagram in FIG. 3a illustrates the arrangement of the parts of the hood 10 of the siphon-like gas distributor 9, which arrangement is radial by way of example.

In a possible procedure, for example, aminonitrile or dinitrile and diamine or a mixture containing aminonitrile, dinitrile and diamine, and water are fed into the upper half of reactor (1). The low boilers (ammonia and water) formed in the reaction can then be enriched in the top of the reactor (1) and removed, while the desired product comprising oligomers and polyamide is obtained as a high boiler in the bottom.

In a further possible procedure, for example, compounds containing nitrile groups, in particular aminonitrile or dinitrile or a mixture containing aminonitrile and dinitrile, and water are fed into the upper half of the reactor (1) and compounds free of nitrile groups, in particular diamines, are fed into the middle or lower part of reactor (1). The low boilers (ammonia and water) formed in the reaction can then be enriched in the top of reactor (1) and removed, while the desired product comprising oligomers and polyamide is obtained as a low boiler in the bottom.

This integrated procedure with continuous product isolation results in ideal, parallel heat exchange and mass transfer with high exergetic efficiency, which moreover is characterized by rapid heating-up of the starting materials and their uniform mixing. The reaction can be carried out under autogenous pressure.

For the present reaction system, the countercurrent transport of prepolymer and the reaction product ammonia, combined with the continuous removal of ammonia via the top product of reactor (1), ensures very low ammonia contents in the parts of the apparatus which contain aminonitrile substantially converted into desired products.

It has been found that higher conversions to the desired product are achieved by the novel process than without continuous removal of ammonia via the top product, with the result that the reaction time is shortened and the formation of undesired secondary components is reduced.

In order to promote the reaction, it is possible to use any desired catalysts which accelerate the hydrolysis and/or condensation. Preferred catalysts are those which either can be introduced in solid form and consequently easily separated from the desired product or are present as a coating on reactor parts.

The present invention relates to a preferably continuous process for hydrolytic reaction of aminonitriles or dinitriles and diamines or a mixture containing aminonitrile, dinitrile and diamine to give polyamide and/or the precursors thereof and, if required, further polyamide-forming mono- and oligomers to give polyamide.

Aminonitrile or dinitrile and diamine or a mixture containing aminonitrile, dinitrile and diamine is or are preferably metered onto an intermediate tray in the upper part of reactor (1). Aminonitrile or dinitrile and diamine or a mixture containing aminonitrile, dinitrile and diamine then flows or flow downward through the apparatus under gravitational force and react continuously with water. The resulting ammonia rises continuously upward owing to its volatility and can be separated off at the top.

In a further preferred embodiment, for example, compounds containing nitrile groups, in particular aminonitrile or dinitrile or a mixture containing aminonitrile and dinitrile, can be metered onto an intermediate tray into the upper part of reactor (1) and compounds free of nitrile groups, in particular diamines, can be fed into the middle or lower part of reactor (1). The compounds containing nitrile groups then flow downward through the apparatus under gravitational force. The resulting ammonia rises continuously upward owing to its volatility and can be separated off at the top.

Starting materials can, if desired, be preheated via the optional top condenser.

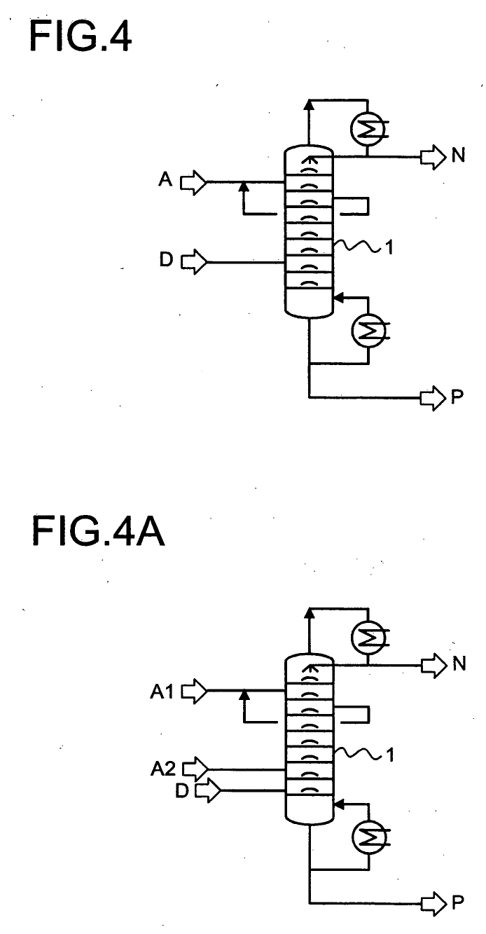

In the drawing, FIG. 4 shows such a diagram illustrating the principle of the novel process:

FIG. 4: Diagram showing the process for a reaction of aminonitriles to give polyamide by the use of a reactor (1). A is aminonitrile, D is steam, N is ammonia and P is polyamide prepolymer.

FIG. 4a: Diagram showing the process for a reaction of dinitrile and diamine to give polyamide by the use of a reactor (1). A1 is dinitrile, A2 is diamine, D is steam, N is ammonia and P is polyamide prepolymer.

It has been found that the introduction of catalyst pellets into the apparatus makes the gas and liquid flow in the column more uniform, too.

The ammonia reduction in the melt can additionally be supported by stripping with inert gases (such as nitrogen) or steam.

The aminonitrile used can in principle be any aminonitrile, i.e. a compound which has both at least one amino group and at least one nitrile group. ω-Aminonitriles are preferred among these, among which in particular w-aminoalkylnitriles having 4 to 12, more preferably 4 to 9, carbon atoms in the alkylene radical or an aminoalkylaryinitrile of 8 to 13 carbon atoms being used, among these in turn preferably those which have an alkyl spacer of at least one carbon atom between the aromatic unit and the amino and nitrile group. Among the aminoalkylarylnitriles, those which have the amino group and nitrile group in the 1,4-position relative to one another are particularly preferred.

Other preferably used ω-aminoalkylnitriles are linear ω-aminoalkylnitriles, the alkylene radical (—CH₂—) preferably containing 4 to 12, more preferably 4 to 9, carbon atoms, such as 6-amino-1-cyanopentane (6-aminocapronitrile), 7-amino-1-cyanohexane, 8-amino-1-cyanoheptane, 9-amino-1-cyanooctane or 10-amino-1-cyanononane, particularly preferably 6-aminocapronitrile.

6-Aminocapronitrile is usually obtained by hydrogenating adipodinitrile by known processes, for example described in DE-A 836, 938, DE-A 848, 654 or U.S. Pat. No. 5,151,543.

Of course, mixtures of a plurality of aminonitriles or mixtures of an aminonitrile with further comonomers, for example caprolactam or the mixture defined below, can also be used.

In principle, all dinitriles, i.e. compounds which have at least two nitrile groups, can be used as the dinitrile. Among these, α,ω-dinitriles are preferred, among the latter in particular α,ω-dinitriles having 4 to 12, more preferably 4 to 9, carbon atoms in the alkylene radical or a cyanoalkylaryinitrile of 7 to 12 carbon atoms being used, among these in turn preferably those which have an alkyl spacer of at least one carbon atom between the aromatic unit and the two nitrile groups. Among the cyanoalkylarylnitriles, those which have the two nitrile groups in the 1,4-position relative to one another are particularly preferred.

Other preferably used α,ω-alkylenedinitriles are linear α,ω-alkylenedinitriles, the alkylene radical (—CH₂—) preferably containing 3 to 11, more preferably 3 to 8, carbon atoms, such as 1,4-dicyanobutane (adipodinitrile), 1,5-dicyanopentane, 1,6-dicyanohexane, 1,7-dicyanoheptane, 1,8-dicyanooctane, 1,9-dicyanonane or 1,10-dicyanodecane, particularly preferably adipodinitrile.

In principle, all diamines, i.e. compounds which have at least two amino groups, may be used as the diamine. Among these, α,ω-diamines are preferred, among which in particular α,ω-diamines having 4 to 14, more preferably 4 to 10, carbon atoms in the alkylene radical or an aminoalkylarylamine of 7 to 12 carbon atoms are used, among which in turn those which have an alkyl spacer of at least one carbon atom between the aromatic unit and the two nitrile groups are preferred. Among the aminoalkylarylamines, those which have the two amino groups in the 1,4-position relative to one another are particularly preferred.

Other α,ω-alkylenediamines which are used are preferably linear α,ω-alkylenediamines, the alkylene radical (—CH₂—) preferably containing 3 to 12, more preferably 3 to 8, carbon atoms, such as 1,4-diaminobutane, 1,5-diaminopentane, 1,6-diaminohexane (hexamethylenediamine), 1,7-diaminoheptane, 1,8-diaminooctane, 1,9-diaminononane or 1,10-diaminodecane, particularly preferably hexamethylenediamine.

If desired, diamines, dinitriles and aminonitriles which are derived from branched alkylenes or arylenes or alkylarylenes may also be used, such as 2-methylglutarodinitrile or 2-methyl-1,5-diaminopentane.

If, in the novel preparation of polyamides, dinitriles and diamines or a mixture containing dinitrile, diamine and aminonitrile is or are used, a molar ratio of the nitrile groups present in the starting materials and capable of polyamide formation to the amino groups present in the starting materials and capable of polyamide formation of from 0.9 to 1.1, preferably from 0.95 to 1.05, in particular from 0.99 to 1.01, particularly preferably 1, have proven advantageous.

For example, dicarboxylic acids, such as alkanedicarboxylic acids of 6 to 12, in particular 6 to 10, carbon atoms, such as adipic acid, pimelic acid, suberic acid, azelaic acid or sebacic acid and terephthalic acid, isophthalic acid and cyclohexanedicarboxylic acid, or amino acids, such as alkaneamino acids of 5 to 12 carbon atoms, in particular α, ω-C₅-C₁₂-amino acids, may be used as further polyamide-forming monomers.

5-Aminopentanoic acid, 6-aminohexanoic acid, 7-aminoheptanoic acid, 8-aminooctanoic acid, 9-aminononanoic acid, 10-aminodecanoic acid, 11-aminoundecanoic acid and 12-aminododecanoic acid, preferably 6-aminohexanoic acid, or the internal amides thereof, i.e. lactams, in particular caprolactam, may be used as the α, ω-C₅-C₁₂-amino acid.

Suitable starting materials in the novel process are furthermore mixtures with aminocarboxylic acid compounds of the formula I
R²R³N—(CH₂)ₘ—C(O)R¹ (I)
where R¹ is —OH, —OC₁₋₁₂-alkyl or —NR²R³, independently of one another, are hydrogen, C₁₋₁₂-alkyl and C₅₋₈-cycloalkyl, and m is 3, 4, 5, 6, 7, 8, 9, 10, 11 or 12.

Particularly preferred aminocarboxylic acid compounds are those in which R¹ is OH, —O—C₁₋₄alkyl, such as —O-methyl, —O-ethyl, —O-n-propyl, —O-isopropyl, —O-n-butyl, —O-sec-butyl, —O-tert-butyl, and —NR²R³, such as —NH₂, —NHMe, —NHEt, —NMe₂ and —NEt₂, and m is 5.

6-Aminocaproic acid, methyl 6-aminocaproate, ethyl 6-aminocaproate, 6-aminocaproic acid methylamide, 6-aminocaproic acid dimethylamide, 6-aminocaproic acid ethylamide, 6-aminocaproic acid diethylamide and 6-aminocaproamide are very particularly preferred.

The starting compounds are commercially available or, for example, can be prepared according to EP-A 0 234 295 and Ind. Eng. Chem. Process Des. Dev. 17 (1978), 9-16.

It is also possible to use any desired mixtures of said compounds, aminocarboxylic acid compounds, lactams, diamines and diacids and salts thereof.

Preferably used polyamide-forming monomers are aminonitriles or dinitriles and diamines or mixtures containing aminonitrile, dinitrile and diamine, together with water, particularly preferably in a molar ratio of from 1:1 to 1:20, based on the total process. Aminocapronitrile, with a molar ACN:water ratio of from 1:1 to 1:10 in the total process is particularly preferred. A mixture of adipodinitrile and hexamethylenediamine, with a molar ratio of the sum of adipodinitrile and hexamethylenediamine to water of from 1:1 to 1:10 in the total process is furthermore particularly preferred. A mixture of adipodinitrile, hexamethylenediamine and aminocapronitrile, with a molar ratio of the sum of adipodinitrile, hexamethylenediamine and aminocapronitrile to water of from 1:1 to 1:10 in the total process is furthermore particularly preferred.

Mixtures of polyamide-forming monomers and oligomers can also be used.

In addition to aminocapronitrile, if desired caprolactam and/or hexamethylenediammonium adipate (AH salt) are preferably used as polyamide-forming monomers.

In addition to adipodinitrile and hexamethylenediamine, if desired caprolactam and/or hexamethylenediammonium adipate (AH salt) are preferably used as polyamide-forming monomers.

In addition to acid catalysts widely described in the literature, such as phosphoric acid, etc., suitable catalysts are in particular heterogeneous catalysts. Brönsted acid catalysts, selected from a beta-zeolite, sheet silicate or a fixed-bed catalyst which substantially comprises TiO₂ with from 70 to 100% of anatase and from 0 to 30% of rutile, in which up to 40% of TiO₂ may be replaced by tungsten oxide, are preferably used.

For example, corresponding TiO₂ modifications, such as FINNTi S150 (from Kemira Pigments Oy, Finland) can be used.

The heterogeneous catalysts can be introduced into the apparatus, for example, as a suspension, sintered onto packings or as optionally coated catalyst packing or bed or internals. They may also be present as a wall coating or bed on the wall in the apparatus so that separation from reaction mixture is easily effected.

The water concentration in the majority of the chambers of reactor (1) which are located underneath the feed point of the aminonitriles or dinitriles or diamines or of the mixture containing dinitrile, diamine and aminonitrile reaches very high concentrations (molar ratio of high boilers to water from about 1:4 to 1:50, preferably from 1:10 to 1:40) so that, even if the components are metered stoichiometrically into the apparatus, water may be present in a superstoichiometric amount in the apparatus itself, which may shift the reaction equilibrium to the product side and may increase the speed with which equilibrium is established.

The temperature for the reaction in the reaction part of reactor (1), i.e. below the starting material feed, should be from about 180 to 300° C., preferably from 200 to 280° C., particularly preferably from 220 to 270° C., depending on the water concentration, the residence time, the use of catalysts and the composition of the starting materials or concentration. The temperatures in the chambers (4) of reactor (1) should advantageously be within a narrow range, preferably within 15° C., preferably within 10° C., in particular within 8° C.

The two-phase procedure permits a reduction in the pressure level required for the reaction since gaseous components need not be kept in the liquid phase—as in the case of a one-phase procedure. Preferably, only the autogenous pressure of the system is established as a function of the temperature. This is from about 10 to 60 bar. The complexity of the apparatus is reduced by the integration of process operations, such as heat exchange and mass transfer, in one and the same apparatus.

With increasing number of chambers (4), the flow profile of the liquid phase in the apparatus approaches ideal plug flow, which leads to a very uniform residence time spectrum in the apparatus.

The desired product obtained has a different molecular weight adjustable within wide limits and different properties depending on the residence time in reactor (1), the process temperatures, the pressure conditions and further process engineering parameters. If desired, further processing of the product for establishing desired product properties can be effected after the reaction.

Advantageously, the product can be subjected to a polycondensation for increasing the molecular weight. Such a polycondensation can be carried out by processes known per se for the preparation and aftertreatment of polyamides, for example in a completely continuous flow tube (VK tube).

The polyamide obtained can be worked up, for example, by methods known per se, as described in detail, for example in DE-A 43 21 683 (page 3, line 54 to page 4, line 3).

In a preferred embodiment, the content of cyclic dimer in the polyamide 6 obtained according to the invention can be reduced further by first extracting the polyamide with an aqueous solution of caprolactam and then water and/or subjecting it to gas-phase extraction (for example, described in EP-A 0 284 968). The low molecular weight components obtained in this aftertreatment, such as caprolactam and linear and cyclic oligomers, can be recycled to the novel process or to the upstream reactor.

The polyamide obtained after the extraction can in general subsequently be dried in a manner known per se.

Advantageously, this can be effected in the presence of inert gases, such as nitrogen or superheated steam, as a heating medium, for example by the countercurrent method. In this way, the desired viscosity, determined in 1% strength by weight solution in 96% sulfuric acid at 25° C., can be established by heating at elevated temperatures, for example at from 150° C. to 190° C.

The novel process is distinguished by a continuous reaction procedure, reduced energy and feedstock costs in a comparatively low complexity of the apparatus. The process can therefore operate more economically than known processes and can give a higher-value product.

The examples which follow illustrate the invention:

### EXAMPLE 1

A continuous stream of caprolactam (9.7% by weight) and water (4.6% by weight), the remainder being nylon 6 prepolymer as used in example 1 of U.S. Pat. No. 6,437,089, is fed to a reactor (1) according to defining claims, comprising 5 stages and a bottom region, in the upper part of the reactor.

This feed stream has a throughput of 20.4 kg/h and a temperature of 250° C.

The pressure in the reactor is regulated and is 18.25 bar gage pressure. The bottom temperature is regulated and is 265° C.

Superheated steam (14.5 kg/h) at 250° C. is added continuously to the bottom.

The temperature curve in the reactor shows an adiabatic trend, the mathematical model calculating the following temperature curve: first chamber 257.6° C., second chamber 257.1° C., third chamber 256.8° C., fourth chamber 256.1° C. and fifth chamber 254° C.

The total residence time in the reactor is 1.75 h, including a residence time of less than 10 minutes in the bottom region.

The results of the calculation give a gas stream from the top of the reactor with a throughput of 14.8 kg/h. The gas stream comprises 1.8% by weight of NH₃, 0.0015% by weight of ACN, 1.2% by weight of caprolactam and about 97% by weight of water.

The mathematical model gives a nylon 6 product stream of 20.1 kg/h with 5.5% by weight of water. The following results are obtained for the terminal groups: 241 mmol/kg of amino, 233 mmol/kg of carboxyl, 3 mmol/kg of amido and 5 mmol/kg of nitrile terminal groups. In the product, the average number of monomer units per molecule is 24.3.

Consequently, a desired product having a quality comparable to that in example 1 of U.S. Pat. No. 6,437,089 is obtained in a technically simpler and more economical manner.

### EXAMPLE 2

A prepolymer is prepared from a mixture of 6-aminocapronitrile and water at a gage pressure of 80 bar and a temperature of 250° C. in a tubular reactor. The residence time is chosen so that the prepolymer comprises 975 mmol/kg of amino, 547 mmol/kg of carboxyl, 423 mmol/kg of amido and 5 mmol/kg of nitrile terminal groups.

A continuous stream of caprolactam (12.3% by weight), water (22.4% by weight) and NH₃ (0.53% by weight), the remainder being nylon 6 prepolymer described above, is fed to a reactor (1) according to defining claims, having 5 stages and a bottom region, in the upper part of the reactor.

This feed stream has a throughput of 37.7 kg/h and a temperature of 235° C.

The pressure in the reactor is regulated and is 28 bar gage pressure. The bottom temperature if regulated and is 275° C.

The temperature curve in the reactor has an adiabatic trend, the mathematical model calculating the following temperature curve: first chamber 238.2° C., second chamber 239.9° C., third chamber 240.7° C., fourth chamber 241° C. and fifth chamber 241.6° C.

The total residence time in the reactor is 1.65 h, including a residence time of less than 10 minutes in the bottom region.

The results of the calculation give a gas stream from the top of the reactor with a throughput of 6.3 kg/h. The gas stream comprises 7.5% by weight of NH₃, 0.000086% by weight of ACN, 0.077% by weight of caprolactam and about 92.4% by weight of water.

The mathematical model gives a nylon 6 product stream of 31.4 kg/h with 8.9% by weight of water. The results for the terminal groups are as follows: 338.2 mmol/kg of amino, 334.6 mmol/kg of carboxyl, 3.3 mmol/kg of amido and 0.3 mmol/kg of nitrile terminal groups. In the product, the average number of monomer units per molecule is 21.9.

1. A process for the preparation of polyamides, oligomers thereof or mixtures thereof, by reaction of aminonitriles or dinitriles and diamines or a mixture comprising aminonitrile, dinitrile and diamine, with water in a reactor having a vertically oriented longitudinal axis, and where the reaction product is discharged from the bottom of the reactor and ammonia formed and any further low molecular weight compounds formed and water are removed from the top, of the reactor wherein the reactor comrnses
at least two chambers (4) arranged one on top of the other in the longitudinal direction,
the chambers (4) being separated from one another by liquid-tight trays (5), and
each chamber (4) being connected by a liquid overflow (6) to the chamber (4) directly underneath; a liquid product stream connected to the liquid overflow (6) of the lowermost chamber (4),
the gas space (7) above the liquid level in each chamber (4) being connected to the chamber (4) arranged directly above in each case by one or more conduit pipes (8) which in each case opens or open into a gas distributor (9) having orifices (11) for gas exit below the liquid level,
and comprising in each case at least one baffle plate (12) which is arranged vertically around each gas distributor (9) and whose upper end terminates below the liquid level and whose lower end terminates above the liquid-tight tray (5) of the chamber (4) and which separates each chamber (4) into one or more gassed (13) and into one or more ungassed (14) spaces.

2. A process as claimed in claim 1, wherein the gas distributor (9) of reactor (1) is siphon-like in the form of a hood (10) closed at the top.

3. A process as claimed in claim 2, wherein the hood of the siphon-like gas distributor (9) is open in its lower part.

4. A process as claimed in claim 2, wherein the hood(s) (1) of the siphon-like gas distributor(s) (9) is or are formed from two or more parts which are connected to one another and in cross section are arranged crosswise and/or parallel or concentrically or radially.

5. A process as claimed claim 1, wherein the number and size of the orifices (11) for gas exit and the distance thereof from the liquid level in the chamber (4) is established in a manner such that the pressure drop of the gaseous stream in the gas distributor (9) is from 0.5 to 50 mbar.

6. A process as claimed claim 1, wherein the orifices (11) for gas exit are arranged in each case at the same height relative to one another.

7. A process as claimed claim 2, wherein the orifices (11) for gas exit are arranged in the lower part of the hood(s) (1) at a distance of from 1 to 15 cm from the lower end of the hood(s) (10).

8. A process as claimed in claim 1, wherein the baffle plate(s) is or are in each case a distance away from the liquid surface and from the tray of the chamber (4) such that substantially no throttling of the liquid flow through the baffle plate(s) (12) occurs.

9. A process as claimed in claim 1, wherein the in each case at least one baffle plate (12) arranged vertically around each gas distributor (9) is in the form of an inserted pipe.

10. A process as claimed in claim 1, wherein the baffle plate(s) and the gas distributor(s) (9) are arranged in such a way that the ungassed cross sectional area is from 10 to 80%, preferably from 40 to 60%, of the sum of gassed and ungassed cross sectional area.

11. A process as claimed in claim 1, wherein a solid catalyst is introduced into one or more, preferably into all, chambers (4) of the reactor (1), in particular as a solid bed or in the form of a catalyst-coated stacked packing, for example of a monolith.

12. A process as claimed in claim 1, wherein an ion exchange resin is introduced into one or more, preferably into all, chambers (4).

13. A process as claimed in claim 1, which is carried out in the presence of Bronsted acid catalysts.

14. A process as claimed in claim 13, wherein Brönsted acid heterogeneous catalysts are used.

15. A process as claimed in claim 1, wherein the reaction is carried out under autogenous pressure.

16. A process as claimed in claim 1, wherein the reactor has a plurality of the theoretical or actual plates.

17. A process as claimed in claim 1, wherein aminonitriles and water in a molar ratio of from 1:1 to 1:20, based on the total process, are used as polyamide-forming monomers.

18. A process as claimed in claim 1, wherein water from steam is used.

19. A process as claimed in claim 1, wherein stripping with an inert gas is additionally effected in the reaction.

20. A process as claimed in claim 1, wherein a further reactor is located upstream of the reactor.

21. A process as claimed in claim 20, wherein the further upstream reactor is operated using a one-phase procedure.

22. A process as claimed in claim 20, wherein the further upstream reactor is operated using a two-phase procedure.

23. A process as claimed in claim 20, wherein an apparatus for separating off the reaction products via the gas phase is present between the further upstream reactor and the reactor.

24. A process as claimed in claim 1, wherein a further reactor is located downstream of the reactor.

25. A process as claimed in claim 24, wherein the further downstream reactor is operated using a one-phase procedure.

26. A process as claimed in claim 24, wherein the further downstream reactor is operated using a two-phase procedure.

27. A process as claimed in claim 1, wherein at least one of the chambers (4) has a heat exchanger.

28. A process as claimed in claim 1, wherein water is fed in liquid or gaseous form into at least one of the chambers (4).

29. A process as claimed in claim 1, wherein the bottom region of the reactor is divided into at least two sub-chambers.

30. A process as claimed in claim 29, wherein the sub-chambers are arranged side by side.

31. A process as claimed in claim 29, wherein the sub-chambers are arranged one on top of the other.

32. A process as claimed in claim 1, wherein a part of the product stream removed from the bottom region of the reactor is fed in liquid form to a heat exchanger, some or all of the water contained in the product stream is converted into the gaseous state with the aid of this heat exchanger and the mixture leaving the heat exchanger is fed to the reactor.

33. A process as claimed in claim 1, wherein a part of the product stream removed from the bottom region of the reactor is fed in liquid form to a heat exchanger, some or all of the water contained in the product stream is converted into the gaseous state with the aid of the heat exchanger, the gaseous water is fed to the reactor and the liquid product leaving the heat exchanger is obtained as desired product.

34. A process as claimed in claim 29, wherein product in liquid form is fed from at least one of the chambers present in the bottom region of the reactor to a heat exchanger, some or all of the water contained in the product stream is converted into the gaseous state with the aid of this heat exchanger and the mixture leaving the heat exchanger is fed to the reactor.

35. A process as claimed in claim 29, wherein product in liquid form is fed from at least one of the chambers present in the bottom region of the reactor to a heat exchanger, some or all of the water contained in the product stream is converted into the gaseous state with the aid of this heat exchanger, the gaseous water is fed to the reactor and the liquid product leaving the heat exchanger is obtained as desired product.

36. A process for the preparation of polyamides, oligomers thereof or mixtures thereof, by reaction of aminonitriles or dinitriles and diamines or a mixture comprising aminonitrile, dinitrile and diamine, with water in a reactor, wherein the reactor comprises:
a vertically oriented longitudinal axis, and where a reaction product is discharged from the bottom of the reactor and ammonia formed and any further low molecular weight compounds formed and water are removed from the top of the reactor;
an upper chamber arranged above a lower chamber in the longitudinal direction, wherein the upper chamber and lower chamber is separated by liquid-tight trays;
a liquid overflow connected to both the upper and the lower chambers and a liquid product stream arranged with the lower chamber;
a gas space separately arranged above the upper and the lower chambers and connected to each chamber by one or more conduit pipes, wherein the one or more conduit pipes are connected to a gas distributor with orifices for gas exit below a liquid level;
at least one baffle plate vertically arranged around the gas distributor, the baffle plate having an upper end that terminates below the liquid level on a lower end that terminates above the liquid-tight trays.

37. A process as claimed claim 36, wherein the number and size of the orifices for gas exit and the distance thereof from the liquid level in the chamber is established in a manner such that the pressure drop of the gaseous stream in the gas distributor is from 0.5 to 50 mbar.

38. A process as claimed in claim 36, wherein the in each case at least one baffle plate is arranged vertically around each gas distributor in the form of an inserted pipe.

39. A process as claimed in claim 36, wherein a solid catalyst is introduced into one or more chambers of the reactor, as a solid bed or in the form of a catalyst-coated stacked packing.

40. The process as claimed in claim 36 wherein the catalyst is a heterogeneous Bronsted acid catalyst.

41. A process as claimed in claim 36, wherein at least one of the chambers (4) has a heat exchanger.

42. A process as claimed in claim 36, wherein the bottom region of reactor (1) is divided into at least two sub-chambers.
